(19) United States
(12) Patent Application Publication
(10) Pub. No.: US 2011/0130997 A1
(43) Pub. Date: Jun. 2, 2011

(54) FLOW METER PROVING METHOD AND SYSTEM

(75) Inventors: Donald Day, Cypress, TX (US); Lausen Scott Tanner, League City, TX (US)

(73) Assignee: Daniel Measurement and Control, Inc., Houston, TX (US)

(21) Appl. No.: 12/920,077

(22) PCT Filed: Feb. 27, 2009
(86) PCT No.: PCT/US09/35423

§ 371 Date: Oct. 6, 2010

Related U.S. Application Data
(60) Provisional application No. 61/031,992, filed on Feb. 27, 2008.

(51) Int. Cl. G01F 25/00; G06F 19/00

(52) U.S. Cl. 702/100; 73/1.16

(57) ABSTRACT

A flow meter prover (120, 220, 320) is provided with multiple pairs of detectors to record multiple calibrated prover volumes with a single pass of the displacer 124. The prover conduit 122 may be fitted with a first pair of detectors (116, 118) for a first calibrated prover volume (V₁) and a second pair of detectors (130, 132) for a second calibrated prover volume (V₂). A single pass of the displacer may trip more pairs of detectors (216, 218, 230, 232, 234, 236) corresponding to more calibrated prover volumes (V₃, V₄, V₅). A flow computer 326 may be configured to record more than two calibrated prover volumes (V₆, V₇, V₈, V₉) using only two pairs of detectors (316, 318, 330, 332) and a displacer (324).

### CROSS-REFERENCE TO RELATED APPLICATIONS

This application is the U.S. National States under 35 U.S.C. §371 of International Patent Application No. PCT/US2009/035423 filed Feb. 29, 2009, which claims the benefit of U.S. Provisional Patent Application Ser. No. 61/031,992 filed Feb. 27, 2008.

### STATEMENT REGARDING FEDERALLY SPONSORED RESEARCH OR DEVELOPMENT

Not applicable.

### BACKGROUND

After hydrocarbons have been removed from the ground, the fluid stream (such as crude oil or natural gas) is transported from place to place via pipelines. It is desirable to know with accuracy the amount of fluid flowing in the stream, and particular accuracy is demanded when the fluid is changing hands, known as “custody transfer.”

Meter proving methods “prove” the accuracy of flow meter measurements. A device called a prover is used to calibrate the flow meter, which is measuring the throughput volume of liquid or gas hydrocarbon products in a pipeline. The prover has a precisely known volume which is calibrated to known and accepted standards of accuracy, such as those prescribed by the American Petroleum Institute (API) or the internationally accepted ISO standards. The precisely known volume of the prover can be defined as the volume of product between two detector switches that is displaced by the passage of a displacer, such as an elastomeric sphere or a piston. The known volume that is displaced by the prover is compared to the throughput volume of the meter. If the comparison yields a volumetric differential of zero or an acceptable variation therefrom, the flow meter is then said to be accurate within the limits of allowed tolerances. If the volumetric differential exceeds the limits allowed, then evidence is provided indicating that the flow meter may not be accurate. Then, the meter throughput volume can be adjusted to reflect the actual flowing volume as identified by the prover. The adjustment may be made with a meter correction factor.

One type of meter is a pulse output meter, which may include a turbine meter, a positive displacement meter, an ultrasonic meter, a coriolis meter or a vortex meter. By way of example, FIGS. 1A and 1B illustrate a system 10 for proving a meter 12, such as a turbine meter. A turbine meter, based on turning of a turbine-like structure within the fluid stream 11, generates electrical pulses 15 where each pulse is proportional to a volume, and the rate of pulses proportional to the volumetric flow rate. A meter volume can be related to a prover volume by flowing a displacer 24, with reference to FIG. 2, first past an upstream detector 16 then a downstream detector 18 in a conduit 22 of prover 20. The volume in the conduit 22 between detectors 16, 18 is a calibrated prover volume. The flowing displacer 24 first actuates or trips the detector 16 such that a start time t₁₆ is indicated to a processor or computer 26. The processor 26 then collects pulses 15 from the meter 12 via signal line 14. The flowing displacer 24 finally trips the detector 18 to indicate a stop time t₁₈ and thereby a series 17 of collected pulses 15 for a single pass of the displacer 24. The number 17 of pulses 15 generated by the turbine meter 12 during the single displacer pass through the calibrated prover volume is indicative of the volume measured by the meter during the time t₁₆ to time t₁₈. By comparing the prover volume to the volume measured by the meter, the meter may be corrected for volume throughput as defined by the prover.

FIG. 3 illustrates another system 50 for proving an ultrasonic flow meter 52, using transit time technology. By ultrasonic it is meant that ultrasonic signals are sent back and forth across the fluid stream 51, and based on various characteristics of the ultrasonic signals a fluid flow may be calculated. Ultrasonic meters generate flow rate data in batches where each batch comprises many sets of ultrasonic signals sent back and forth across the fluid during a period of time (e.g., one second). The flow rate determined by the meter corresponds to an average flow rate over the batch time period rather than a flow rate at a particular point in time.

Some provers are unidirectional, meaning the displacer travels in one direction between the detectors and requires a displacer handling device. With reference to FIGS. 1B and 4, other provers are bidirectional, wherein a single displacer 24 is cycled back and forth within a calibrated meter prover barrel or conduit 22 having a proving section 25 therein defined by the spacing of the pair of detectors 16, 18. The proving section 25 includes the calibrated prover volume. Referring to FIG. 1B, a four-way valve 60 controls the bi-directional movement of the displacer. In a first position, the four-way valve 60 allows fluid from a pipeline 13 through a conduit 62 and into the prover loop 29 via a conduit 64. The fluid flows in a first direction through the prover loop 29 while pushing the displacer from a first position through the proving section 25. The displacer stops at a second position past the detector 18, and the fluid cycles back into the four-way valve 66 via conduit 66 and into the pipeline 13 via conduit 68. The four-way valve 60 may then be actuated to a second position, wherein flow from the pipeline 13 goes through the conduit 68, through the four-way valve 60, through the conduit 66, through the proving section 25, through the conduit 64, and back into the four-way valve 60 and into the pipeline 13 via conduit 62. During this fluid flow, the displacer is cycled back from the second position to the first position past the detector 16. The actuation command for the four-way valve 60 may be issued by the flow computer, such as the processor 26. A “pass” may refer to a single pass of the displacer in one direction through the proving section and past the detectors. A “trial run” may refer to the movement of the displacer in one direction, then the other, for two passes of the displacer from its original position and back.

API requires proving by comparing a prover volume to a meter volume, with the meter volume determined from pulses. The pulses are obtained directly from the meter. For an ultrasonic flow meter, conforming to this standard dictates that data from the meter be converted to pulses for purposes of measurement and proving. Such a conversion may be carried out in an internal processor 54, with the pulses supplied to the external processor 26 to prove the ultrasonic meter 52 as described above. API also requires that a minimum number of pulses (such as 10,000) be analyzed with a certain level of uncertainty (such as plus or minus one pulse in 10,000) and volume repeatability (such as 0.02%). Recently, particularly with ultrasonic flow meters, API has issued norms regarding meter proving. Such norms include defining the number of proving runs for a specified uncertainty, and relating the number of proving runs and recommended prover volume to achieve the required meter factor uncertainty of ±0.027%.

The pulses generated by the meter are transmitted to the flow computer, such as processor 26, where the pulses are accumulated and translated back to what the actual throughput volume of the meter is. A meter factor is then determined by a comparison of the calibrated prover volume to the actual meter throughput volume. The industry has seen a significant increase in smart primary flow measurement devices such as ultrasonic meters, coriolis meters and vortex meters. Such meters create a manufactured volumetric pulse output, produced by the internal processor 54, which lags the real flow. An inherent latency exists in these meters, caused by the calculations run by the processor 54 to translate actual flow by the meter 52 into a pulse train output from the processor 54. During normal operation, the lag between the manufactured volumetric pulse and the actual volume has very little impact on the measurement accuracy, but during the proving process, could cause poor run to run repeatability and introduce a bias error in the meter factor calculation. A primary way to address the pulse train lag problem with manufactured pulse devices is to increase the number of prover runs.

To meet the level of uncertainty required by API, described above, liquid ultrasonic meters, for example, require additional proving trial runs. The size of the prover will affect the number of trial runs needed to accomplish, on a repeatable basis, a population of volumes for a statistically accurate sample. To build such a population, multiple passes of the displacer through the prover are needed. Increasing prover sizes and proving duration to build the statistical volume populations is undesirable. Larger size provers are costly to build and maintain, and have a large footprint. Long proving duration requires more attention from operators, allows significant volumes of product to pass through the meter before it is calibrated, and adds wear to the components. Therefore, it is desirable to decrease prover sizes and volumes, as well as proving duration. As a result, operator time is used more efficiently. Further, parameters required for proving, in particular temperature, will have less opportunity to become unstable.

### BRIEF DESCRIPTION OF THE DRAWINGS

For a detailed description of exemplary embodiments of the disclosure, reference will now be made to the accompanying drawings in which:

FIG. 1A is a schematic representation of a system for proving a meter, such as a turbine meter;

FIG. 1B is a schematic representation of the details of the prover loop portion of the system of FIG. 1A;

FIG. 2 is an enlarged view of the displacer and conduit of the prover of FIGS. 1A and 1B;

FIG. 3 is a schematic representation of another system for proving a meter, such as an ultrasonic meter;

FIG. 4 is an enlarged view of the proving section of the provers of FIGS. 1A-3;

FIG. 5 is an enlarged, schematic view of a portion of a prover in accordance with an embodiment of the disclosure;

FIG. 6 is an enlarged view of the prover of FIG. 5 showing the proving section;

FIG. 7 is an alternative embodiment of a prover with multiple detector pairs and calibrated volumes, in accordance with principles of the disclosure;

FIG. 8 is another alternative embodiment showing a schematic view of a portion of a prover having two detector pairs and four calibrated volumes; and

FIG. 9 is a flow chart for methods of operation of a prover and processor in accordance with principles of the disclosure.

### DETAILED DESCRIPTION

In the drawings and description that follow, like parts are typically marked throughout the specification and drawings with the same reference numerals. The drawing figures are not necessarily to scale. Certain features of the disclosure may be shown exaggerated in scale or in somewhat schematic form and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed below may be employed separately or in any suitable combination to produce desired results.

Unless otherwise specified, any use of any form of the terms “connect”, “engage”, “couple”, “attach”, or any other term describing an interaction between elements is not meant to limit the interaction to direct interaction between the elements and may also include indirect interaction between the elements described.

In the following discussion and in the claims, the terms “including” and “comprising” are used in an open-ended fashion, and thus should be interpreted to mean “including, but not limited to . . . ”.

In the following discussion and in the claims, the term “fluid” may refer to a liquid or gas and is not solely related to any particular type of fluid such as hydrocarbons. The various characteristics mentioned above, as well as other features and characteristics described in more detail below, will be readily apparent to those skilled in the art upon reading the following detailed description of the embodiments, and by referring to the accompanying drawings.

The present disclosure, in part, describes achieving the requisite number of proving runs with a lesser or minimum number of displacer passes through the calibrated proving section of the prover. In some embodiments, multiple calibrated prover volumes are recorded with one displacer pass through the proving section. In one embodiment, multiple pairs of detectors are tripped during a single displacer pass, with each pair of tripped detectors representing a calibrated prover volume. The attached proving computer or processor mathematically computes the meter correction factor for each calibrated volume independently, then combines each volume meter correction factor into a single resultant meter factor. Thus, a meter prover system and method is provided for a single displacer pass to record multiple calibrated prover volumes to a flow computer. The flow computer is configured to record and analyze the multiple calibrated volumes created with each displacer pass, to collect populations of same in a reduced prover duration, and to calculate meter factors and analyze same. In some embodiments, a prover achieves single pass, multi-volume proving for desirably decreasing the proving duration.

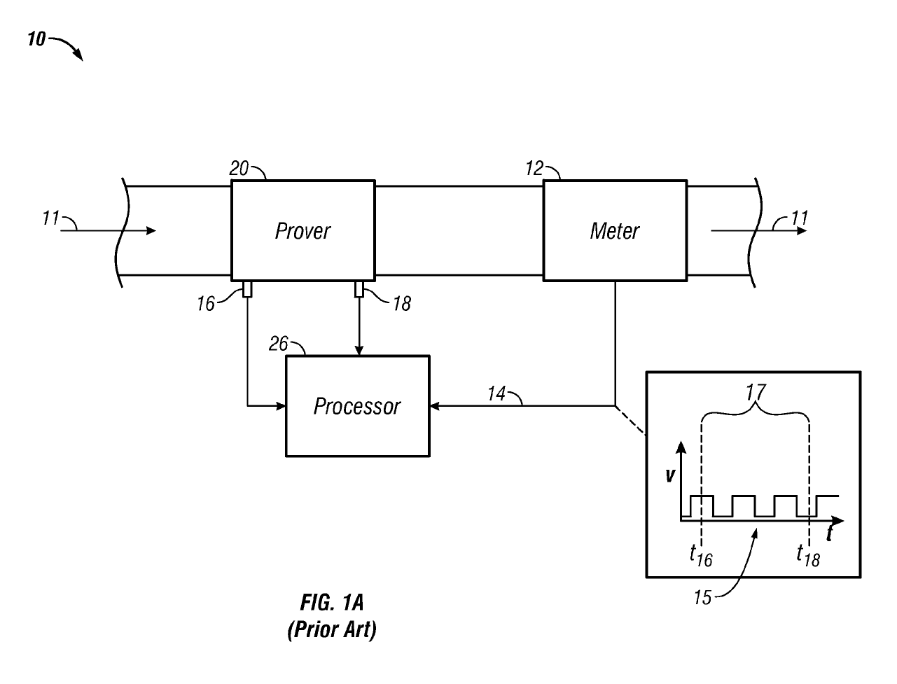

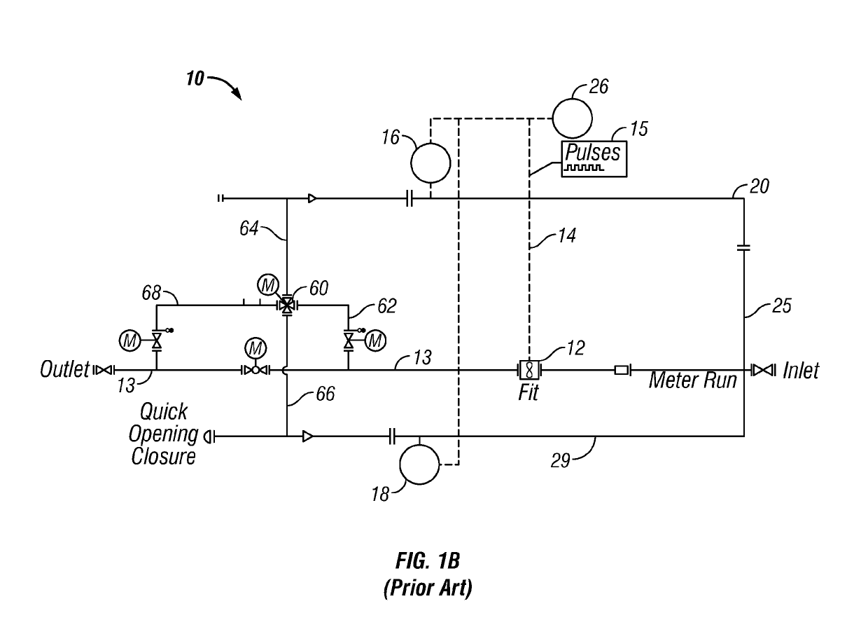

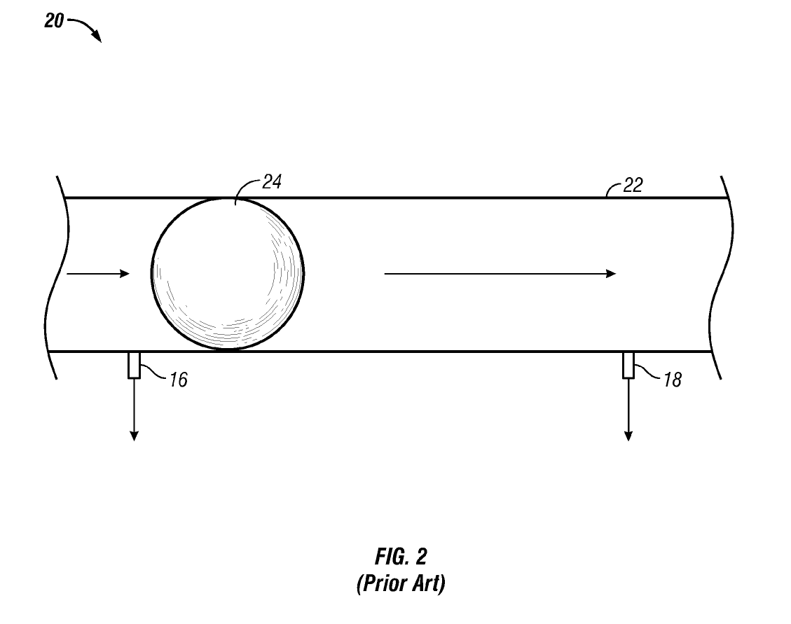

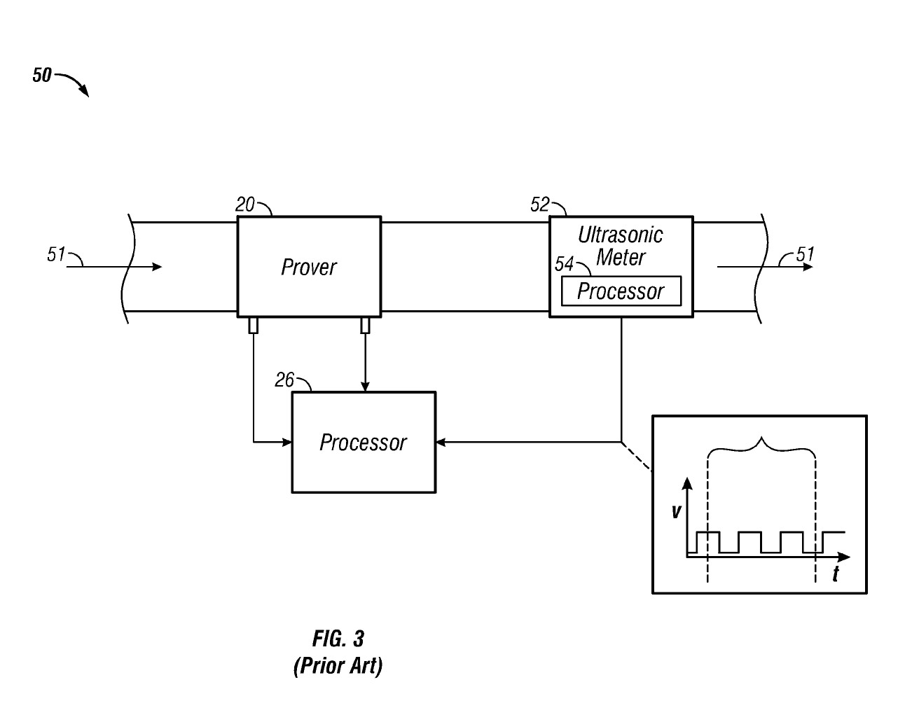

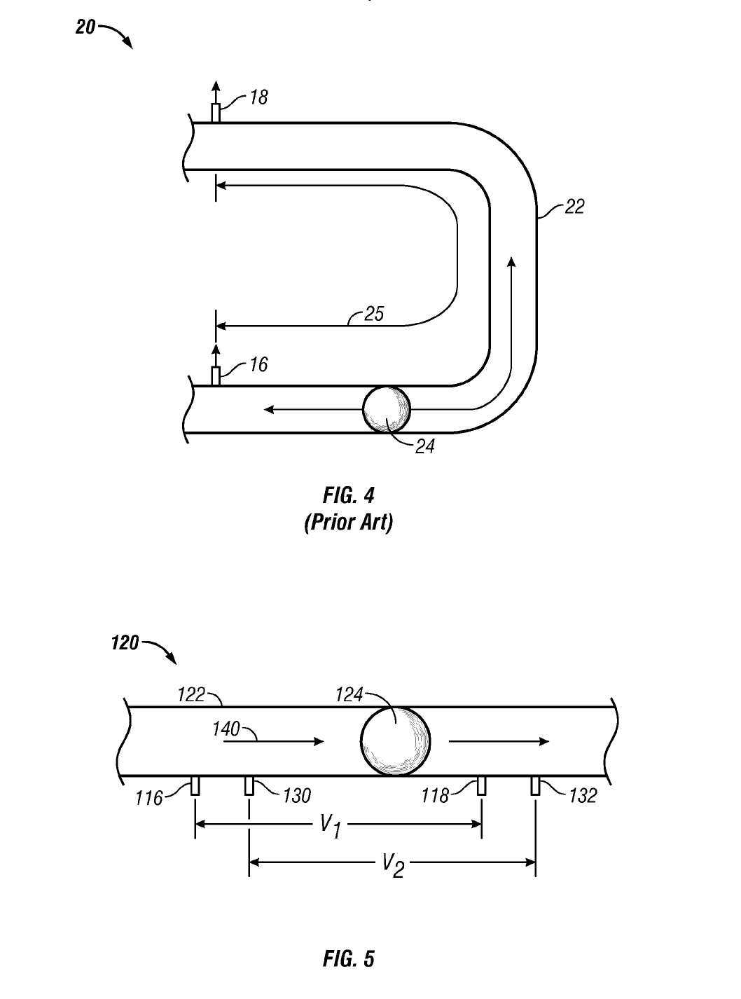

Referring initially to FIG. 5, a portion of a prover 120 in schematic form shows a proving section of a conduit 122 having a displacer 124 therein. The displacer 124 is bidirectionally displaceable between a first position to the left of a detector 116 and a second position to the right of a detector 132. The detector 116 is paired with a detector 118 to operate in conjunction with one another to indicate to a flow computer to record a finite number of pulses from a meter while the displacer passes through a calibrated volume V₁. A detector 130 is paired with a detector 132 to actuate in conjunction with one another to indicate to the flow computer when to start and stop recording meter output pulses corresponding to a calibrated volume V₂. Thus, the first pair of detectors 116, 118 can be said to define the first calibrated volume V₁ of the prover conduit 122, and the second pair of detectors 130, 132 can be said to define the second calibrated volume V₂ of the prover conduit 122. As the displacer 124 travels in the direction shown by arrow 140, the displacer first actuates the detector 116 sending a signal to a processor, such as the processor 26 in FIGS. 1 and 3. The displacer 124 then actuates the detector 130, and the processor records that signal. Next, the displacer 124 actuates the detector 118, thereby indicating to the processor that the displacer has displaced the volume V₁. Finally, the displacer 124 actuates the detector 132, thereby stopping the pulse recording for the volume V₂ and recording same in the processor. The displacer 124 can also travel in the opposite direction, instead indicating the volume V₂ first, then the volume V₁.

Calibrated prover volumes are compared to meter throughput volumes by counting pulses generated by the meter, as previously described. Upon actuating a first detector of a pair, such as the detector 116, a counter internal to the processor 26 is started that counts pulses emanating from the meter. The processor is signaled to stop counting pulses when the second detector of a pair, or defined calibrated volume, is actuated. The number of pulses counted for the calibrated volume that is tripped will generally be greater than 10,000 pulses, as dictated by API. As previously described, a pulse is proportional to a flow volume, and the rate of pulses proportional to flow rate. The processor also includes a known K-factor, which is an expression of pulse per unit volume. For example, for a large volume prover, the K-factor may be 525 pulses per barrel of liquid hydrocarbons. The processor may be configured to then divide the number of counted pulses by the K-factor, and further apply temperature and pressure corrections: 1) at the meter to standard conditions, and 2) at the calibrated section of prover conduit to correct the base volume and the fluid through the prover. Such application of a K-factor is known to one skilled in the art. Finally, a meter correction factor is generated by the processor, which is a ratio of known volume to volume calculated from the meter. With multiple calculations of the meter factor generated, the processor can then look at the repeatability of the meter factor to within accepted percentages, for example 0.02%.

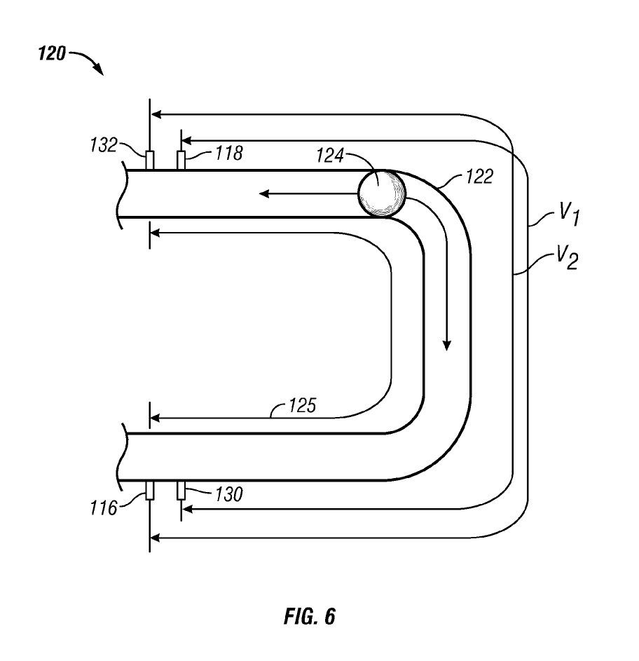

Referring now to FIG. 6, the prover 120 is again shown and the relationships between the detectors 116, 118 and detectors 130, 132 can be seen to define the volumes V₁ and V₂, respectively. The displacer will travel to start and stops positions beyond the proving section 125 defined between the detectors 116 and 132. The multiple pairs of detectors are tripped to indicate the calibrated volumes V₁ and V₂ to the flow computer with each pass of the displacer through the proving section 125.

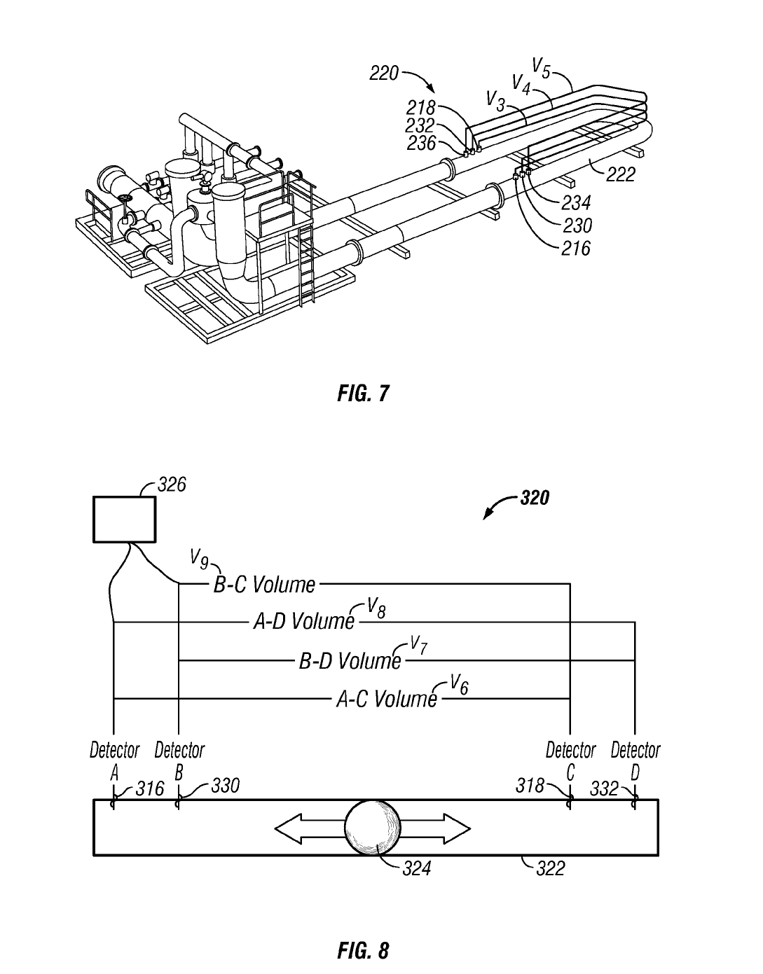

Referring next to FIG. 7, other prover system embodiments include additional detector pairs that define additional calibrated volumes that can be recorded by the flow computer with each pass of the displacer. A prover 220 having conduit 222 includes a first pair of detectors 216, 218, a second pair of detectors 230, 232 and a third pair of detectors 234, 236. The first pair of detectors 216, 218 defines a calibrated prover volume V₃, the second pair of detectors 230, 232 defines a calibrated prover volume V₄ and the third pair of detectors 234, 236 defines a calibrated prover volume V₅. Some embodiments may include more detector pairs that indicate additional calibrated volumes with each displacer pass. Because each pass of the displacer indicates more calibrated volumes, and their corresponding pulse meter outputs, the overall proving duration can be reduced in direct relationship to the number of detector pairs and associated calibrated volumes.

In some embodiments, the number of tripped volumes can be maximized with a minimal number of detector pairs. For example, with reference to FIG. 8, a prover 320 includes a prover conduit 322 having a displacer 324 therein, a first detector pair 316, 318 and a second detector pair 330, 332. However, instead of detector pair 316, 318 only being operable relative to each other (same with detector pair 330, 332), the detectors are interoperable to indicate more than just two calibrated volumes, as is shown in FIG. 5. First, the detector 316 is operable to indicate a volume V₆ with the detector 318. Second, the detector 316 is also operable to indicate a volume V₈ with the detector 332. Third, the detector 330 is operable to indicate a volume V₇ with the detector 332. Fourth, the detector 330 is also operable to indicate a volume V₉ with the detector 318. Thus, four calibrated volumes may be indicated with one pass of the displacer 324 over the two detector pairs 316, 318 and 330, 332 (or, a total of four detectors). The flow computer 326 is configured to first record actuation of the detector 316, then the actuation of the detector 330, then the actuation of the detector 318 and the simultaneous indication of the volumes V₆ and V₉, then finally the actuation of the detector 332 and the simultaneous indication of the volumes V₇ and V₈. The processor 326 is also configured to count individual sets of pulses from the meter for each indicated volume.

Additionally, the processor 326, or other processors coupled to the various prover embodiments described herein and configured to record the indicated volumes, are operable to perform additional functions. First, as the displacer trips each independent pair of detectors and corresponding calibrated volume, the processor records a set of volumes for each independent calibrated volume. The required sample population is built up until the required repeatability and uncertainty is achieved as required by the applicable proving norms. Then, the processor compares the set of volumes to the meter throughput and calculates a meter correction factor for each of the independent calibrated volumes. Finally, the processor is operable to combine the meter factors generated for each of the independent calibrated volumes into a single, combined meter factor. This final combined meter factor can then be used to adjust the meter volume throughput to reflect flowing volume as identified by the prover.

For example, with respect to the prover 120, a volume V₁ and a volume V₂ is indicated to the processor with each pass back and forth of the displacer 124. With each pass, another volume (with a corresponding set of pulses from the meter) is added to the set of volumes for V₁ and independently for V₂, until each independent sample population is gathered to the required repeatability and uncertainty standards. The processor may then, using comparison to the meter throughput data, generate a meter factor F₁ for the set of volumes related to the calibrated volume V₁ and a second meter factor F₂ for the set of volumes related to the calibrated volume V₂. Finally, the processor is operable to combine the meter factors F₁ and F₂ for a combined, resultant meter factor F_{C} that can be used to adjust the measured meter throughput volume to reflect the actual flowing volume as identified by the prover.

In other embodiments, with reference to FIG. 7, multiple displacer passes will create independent sets of volumes for each of the calibrated volumes V₃, V₄ and V₅. The processor generates meter factors F₃, F₄ and F₅ for each of the independent sets of volumes and finally provides a combined meter factor F_{C1} for adjustment of the meter throughput volume. In still other embodiments, with reference to FIG. 8, multiple displacer passes will create independent sets of volumes for each of the calibrated volumes V₆, V₇, V_{g} and V₉. The processor 326 generates meter factors F₆, F₇, F₈ and F₉ for each of the independent sets of volumes and finally provides a combined meter factor F_{C2} for adjustment of the meter throughput volume.

In alternative embodiments, a meter factor is calculated by the processor for each indicated volume with each displacer pass, and the individual meter factors are gathered to build a statistical population. The population of meter factors for each calibrated volumes is gathered to the required repeatability and uncertainty standards. The meter factor F₁ (or F₂, or F₃, etc.) is then generated from the population of meter factors. The combined, resultant meter factor may then be calculated as previously described.

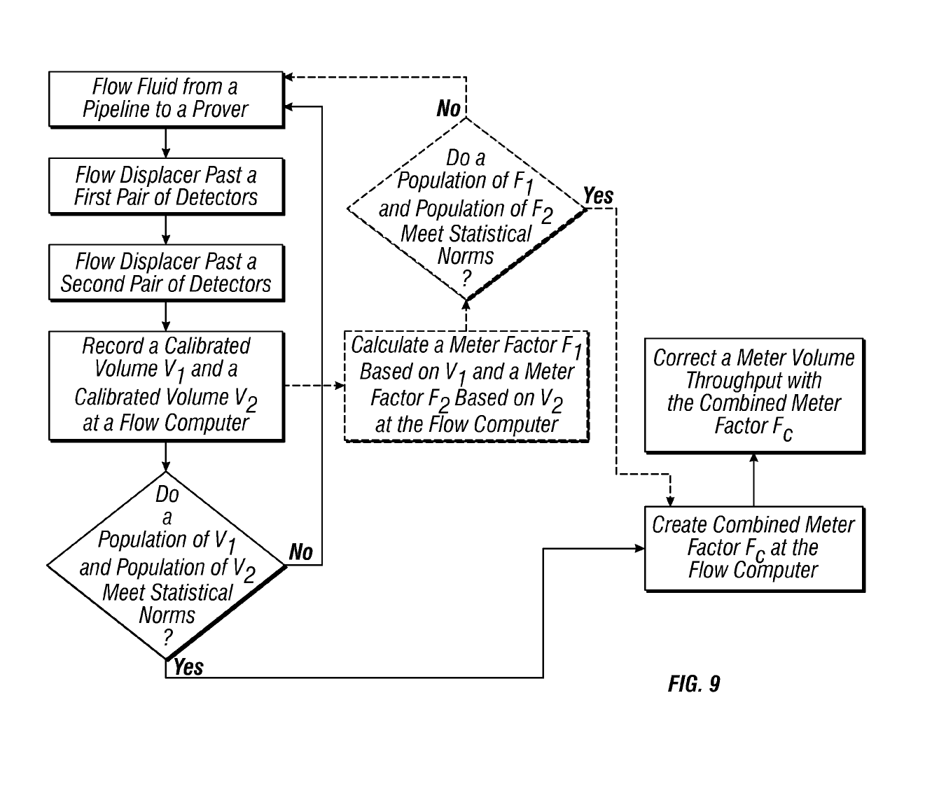

With reference to FIG. 9, the processes just described are shown schematically in a flow chart 400. First, a fluid flow is directed form a pipeline to a prover at 402. Then, a displacer is moved by the flow past a first pair of detectors at 404. Next, the displacer is moved by the flow past a second pair of detectors at 406. A calibrated volume V₁ and a calibrated volume V₂ is recorded at a flow computer at 408. A determination is made at 410 whether the populations of V₁ and V₂ meet statistical norms or standards. If no, then the process is directed back to 402. If yes, the process continues to 412 where a combined meter factor F_{c} is created at the flow computer. At 414, the actual meter volume throughput measurement is corrected using the combined meter factor F_{c} which, according to the principles disclosed herein, is calculated using less physical passes of the prover displacer while achieving the appropriate statistical population of prover volumes. In alternative embodiments, after 408, a meter factor F₁ is calculated based on V₁ and a meter factor F₂ is calculated based on V₂ in the flow computer at 416. Next, a determination is made at 418 whether the populations of F₁ and F₂ meet statistical norms or standards. If no, then the process is directed back to 402. If yes, the process continues to 412 where the combined meter factor F_{c} is created at the flow computer.

The processor 326, and other processors operable with the various single pass, multi-volume prover embodiments described herein, may be based on a stand alone processor or a microcontroller. In other embodiments, the functionality of the processor may be implemented by way of a programmable logic device (PLD), field programmable gate array (FPGA), application specific integrated circuit (ASIC), or the like. In certain embodiments, the processor may be based on a liquid flow computer such as the Emerson ROC800 Liquid Flow Computer. In all embodiments, the processor is configured to communicate with the various prover embodiments described herein having multiple, simultaneously operable detector pairs that indicate multiple calibrated volumes (and sets of pulses) for each pass of a displacer through the proving section. The processor is also configured to develop independent sets of volumes to build sample populations according to statistical norms promulgated by API and others, and to generate a plurality of meter factors and combined meter factors for adjusting the meter throughput volume to actual flowing conditions.

While the flow meters 12, 52 are shown downstream of the prover 20, in alternative embodiments the flow meter may be equivalently upstream of the prover 20. In other embodiments, the meter is removed from the pipeline and taken to a proving facility or laboratory. Furthermore, the meters 12, 52 may also include coriolis or vortex meters, or other meters, in alternative embodiments.

In some situations it is normal to use a prover volume sufficient for calibration of both large and small meters, although the flow rate is higher for large meters to meet throughput conditions. Utilizing a prover designed for large meters to prove small meters results in low throughput velocities and thus extended proving duration as the displacer moves slower through the prover. Thus, where a large meter of 12-inch or 16-inch internal diameter can be proved in 30 or 40 minutes, a 4-inch meter proven against the same prover could take eight hours. However, if one displacer pass can achieve multiple volume results instead of only one, time to prove will be considerably shortened. Multiple pairs of sensors or detectors allows an operator to build a statistical population more quickly. The various embodiments described herein provide a prover with such characteristics.

Another consideration taken into account by the various embodiments provided herein is prover volume. Overall prover volume and size can be reduced if additional calibrated proving volumes and sets of pulses are indicated and recorded with the displacer passes.

Various teachings herein can be employed in suitable combinations for desired results. The embodiments described are exemplary only, and do not limit the disclosure. The scope of the present disclosure is defined by the following claims.

What is claimed is:

1. A flow meter prover comprising:
a conduit having a proving section;
a displacer disposed in the conduit and displaceable through the proving section between a first position and second position;
a first pair of detectors disposed in the proving section between the first and second positions defining a first calibrated volume; and
a second pair of detectors disposed in the proving section between the first and second positions defining a second calibrated volume;
wherein the first and second pairs of detectors are operable to communicate to a processor the first and second calibrated volumes with each pass of the displacer between the first and second positions;
wherein the processor is configured to build a first sample population of the first calibrated volume and a second sample population of the second calibrated volume.

2. (canceled)

3. The flow meter prover of claim 1 further comprising a plurality of pairs of detectors for communicating a plurality of calibrated volumes with each pass of the displacer between the first and second positions.

4. The flow meter prover of claim 1 wherein the processor is configured to receive:
signals from the first and second pairs of detectors representing the first and second calibrated volumes with each pass of the displacer between the first and second positions;
a first set of pulses from a meter corresponding to the first calibrated volume; and
a second set of pulses from a meter corresponding to the second calibrated volume.

5. (canceled)

6. The flow meter prover of claim 1 wherein the processor is configured to calculate a first meter factor based only on the first sample population and a second meter factor based only on the second sample population.

7. The meter prover of claim 6 wherein the processor is configured to calculate a combined meter factor based on the first and second meter factors.

8. A method of proving a flow meter comprising:
passing a displacer through a prover multiple times;
activating a first pair of detectors with the displacer for each pass of the displacer, the first pair of detectors defining a first calibrated volume;
indicating the first calibrated volume with each pass of the displacer;
activating a second pair of detectors with the displacer for each pass of the displacer, the second pair of detectors defining a second calibrated volume;
indicating the second calibrated volume with each pass of the displacer;
building a first sample population of the indicated first calibrated volumes; and
building a second sample population of the indicated second calibrated volumes.

9. The method of claim 8 further comprising recording a plurality of sets of meter pulses for each calibrated volume.

10. (canceled)

11. The method of claim 8 further comprising:
developing a first meter factor from the first sample population; and
developing a second meter factor from the second sample population.

12. The method of claim 11 further comprising calculating a combined meter factor from the first and second meter factors.

13. The method of claim 12 further comprising adjusting a meter throughput volume with the combined meter factor.

14. (canceled)

15. A flow meter prover computer comprising:
a processor coupled to a single pass, multi-volume prover having a displacer;
wherein the processor is configured to receive a first calibrated volume signal with a corresponding set of meter pulse signals, and a second calibrated volume signal with a corresponding set of meter pulse signals; wherein all signals are generated during a single pass of the displacer; and
wherein the processor is further configured to:
build a first sample population based only on a plurality of the first calibrated volume signal; and
build a second sample population based only on a plurality of the second calibrated volume signal.

16. (canceled)

17. The flow meter prover computer of claim 15 wherein the sample populations are built according to API prover standards.

18. The flow meter prover computer of claim 15 wherein the processor is further configured to:
generate a first meter factor based only on the first sample population; and
generate a second meter factor based only on the second sample population.

19. The flow meter prover computer of claim 18 wherein the processor is configured to generate a combined meter factor based on the first and second meter factors.

20. The flow meter prover computer of claim 15 wherein the calibrated volume sample populations are based on signals from a plurality of pairs of detectors on the prover, and the processor is further configured to:
generate a plurality of independent meter factors, each meter factor related to a single sample population;
generate a combined meter factor based on the plurality of independent meter factors; and
apply the combined meter factor to a meter throughput volume.
